(19) United States
(12) Patent Application Publication
(10) Pub. No.: US 2015/0025838 A1
(43) Pub. Date: Jan. 22, 2015

(54) POSITION ESTIMATION DEVICE, POSITION ESTIMATION METHOD, AND INTEGRATED CIRCUIT

(71) Applicant: Panasonic Corporation, Osaka (JP)

(72) Inventors: Kazunori Yamada, Hyogo (JP); Mitsuaki Oshima, Kyoto (JP)

(21) Appl. No.: 13/877,664

(22) PCT Filed: Oct. 29, 2012
(86) PCT No.: PCT/JP2012/006915

§ 371 Date: Apr. 4, 2013

(30) Foreign Application Priority Data
Nov. 15, 2011 (JP) 2011-250170

(51) Int. Cl. G01B 7/004; G01P 3/00; G01B 21/00

(52) U.S. Cl. CPC G01B 7/004; G01B 21/00; G01P 3/00
USPC 702/150

(57) ABSTRACT

A position estimation device includes: a position estimation unit that estimates current position coordinates of the position estimation device; a pointing direction detection unit that detects a pointing direction pointed by a user using the position estimation device; a pointing target detection unit that detects a pointing target pointed by the user, based on the detected pointing direction; a concentration calculation unit that specifies, as a concentrated area, an area in which a position pointed in the detected pointing direction in a predetermined time period immediately before the pointing target is detected is included for at least a threshold time period and in which the pointing target is not present, and calculates a concentrated direction which is from the position of the position estimation device in the predetermined time period to the concentrated area; and a position correction unit that corrects the current position coordinates using the calculated concentrated direction.

### TECHNICAL FIELD

The present invention relates to a position estimation device, a position estimation method, and an integrated circuit for estimating a position of the device.

### BACKGROUND ART

In home networks in recent years, not only AV home appliances are coordinated via IP (Internet Protocol) connection of Ethernet® or wireless LAN (Local Area Network), but also a home appliance coordination function of connecting various home appliances that also include home appliances other than AV home appliances via a network to establish their coordination is in the process of introduction. To realize such a home appliance coordination function, the development of HEMS (Home Energy Management System) capable of, for example, managing power consumption for environmental purposes and powering ON/OFF from outside the home is currently in progress.

Upon realizing such a home appliance coordination function, if a position of a user can be accurately estimated, then it is possible to perform home appliance control in accordance with the position of the user. This is expected to contribute to improved operability and improved accuracy in home appliance control.

There is, however, a problem that a GPS (Global Positioning System) function is often unable to be used for position estimation indoors and so the position of the user cannot be accurately estimated.

In view of this, a position correction technique for solving the above-mentioned problem to improve position estimation accuracy is proposed in Patent Literature (PTL) 1.

### CITATION LIST

### Patent Literature

[PTL 1]
Japanese Patent No. 3915654

### SUMMARY OF INVENTION

### Technical Problem

However, the technique disclosed in PTL 1 is problematic in terms of cost, because equipment holding position information needs to be installed in an indoor facility.

The present invention is intended to solve the problems described above, and has an object of providing a position estimation device, a position estimation method, and an integrated circuit capable of estimating a position of the device with high accuracy without requiring installation of special equipment indoors.

### Solution to Problem

To solve the problems described above, a position estimation device according to the present invention is a position estimation device that estimates a position of the position estimation device, the position estimation device including: a position estimation unit that estimates current position coordinates indicating a current position of the position estimation device; a pointing direction detection unit that detects a pointing direction which is a direction pointed by a user using the position estimation device; a target detection unit that detects a pointing target which is a target object pointed by the user, based on the pointing direction detected by the pointing direction detection unit; a concentration calculation unit that specifies, as a concentrated area, an area in which a position pointed in the pointing direction detected by the pointing direction detection unit in a predetermined time period immediately before the pointing target is detected by the target detection unit is included for at least a threshold time period and in which the pointing target is not present, and calculates a concentrated direction which is a direction from the position of the position estimation device in the predetermined time period to the specified concentrated area; and a position correction unit that corrects the current position coordinates using the calculated concentrated direction.

Note that such an overall or specific embodiment may be implemented by a system, a method, an integrated circuit, a computer program, or a computer-readable recording medium such as a CD-ROM, or any combination of a system, a method, an integrated circuit, a computer program, and a recording medium.

### Advantageous Effects of Invention

The position estimation device according to the present invention can estimate the position of the position estimation device with high accuracy without requiring installation of special equipment, such as a dedicated antenna of indoor GPS, indoors.

### BRIEF DESCRIPTION OF DRAWINGS

FIG. 1 is a functional block diagram of a position estimation device according to an embodiment of the present invention.

FIG. 2A is a diagram showing a difference between positional relationships recognized by a user and a mobile terminal for a pointing target according to the embodiment.

FIG. 2B is a diagram showing the difference between the positional relationships recognized by the user and the mobile terminal for the pointing target according to the embodiment.

FIG. 3 is a diagram for describing an example of a method whereby the mobile terminal determines whether or not estimated position information has an error according to the embodiment.

FIG. 4 is a diagram for describing an example of a method whereby, in the case of determining that estimated position information has an error, the mobile terminal corrects the position information according to the embodiment.

FIG. 5 is a diagram for describing an example of a method whereby the mobile terminal determines whether or not there is a concentrated area of a pointing direction according to the embodiment.

FIG. 6A is a diagram showing a difference between positional relationships recognized by the user and the mobile terminal for the pointing target according to the embodiment.

FIG. 6B is a diagram showing the difference between the positional relationships recognized by the user and the mobile terminal for the pointing target according to the embodiment.

FIG. 7 is a diagram for describing an example of a method whereby, in the case of determining that estimated position information has an error, the mobile terminal corrects the position information according to the embodiment.

FIG. 8A is a diagram for describing an example of a method whereby, in the case of determining that estimated position information has an error, the mobile terminal corrects the position information according to the embodiment.

FIG. 8B is a diagram for describing an example of a method whereby, in the case where estimated position information has an error, the mobile terminal corrects the position information according to the embodiment.

FIG. 9 is a flowchart for describing process flow of the mobile terminal according to the embodiment.

FIG. 10 is a flowchart for describing process flow of the mobile terminal according to the embodiment.

FIG. 11 is a flowchart for describing process flow of the mobile terminal according to the embodiment.

FIG. 12 is a flowchart for describing process flow of the mobile terminal according to the embodiment.

FIG. 13 is a flowchart for describing process flow of the mobile terminal according to the embodiment.

FIG. 14 is a flowchart for describing process flow of the mobile terminal according to the embodiment.

FIG. 15 is a functional block diagram showing a minimum structure of a position estimation device.

### DESCRIPTION OF EMBODIMENTS

### Circumstances Leading to Conceiving of an Aspect of the Present Invention

The inventors of the present invention have found the following problems with the position estimation devices described in the “Background Art” section.

Upon realizing a home appliance coordination function by HEMS or the like, if a position of a user can be accurately estimated, then it is possible to perform home appliance control in accordance with the position of the user. This is expected to contribute to improved operability and improved accuracy in home appliance control.

There is, however, a problem that a GPS (Global Positioning System) function is often unable to be used for position estimation indoors and so the position of the user cannot be accurately estimated.

Accordingly, there are proposed a position estimation device that estimates the position of the position estimation device using an indoor use GPS antenna (indoor GPS antenna), and a position estimation device that detects a radio wave of each of a plurality of wireless LANs and estimates the position of the position estimation device from an electric field strength of the radio wave.

However, the position estimation device using the indoor GPS antenna has a problem that a complex system needs to be built in order to use the position estimation device, which is burdensome to the user. As an example, in the position estimation device using the indoor GPS antenna, information of the indoor GPS antenna and a base station is necessary. Accordingly, when installing the indoor GPS antenna, the user needs to perform burdensome operations such as inputting the position of the indoor GPS antenna to the position estimation device.

In the position estimation device using the electric field strength of the radio wave of each of the plurality of wireless LANs, typically electric field strength information of a radio wave from an access point which is a base station device needs to be measured at intervals of, for example, several meters and registered beforehand. This enables the position estimation device such as a mobile terminal to, when obtaining electric field strength information, compare the obtained electric field strength information with the electric field strength information measured beforehand and estimate the position. However, the position estimation device has a problem that highly accurate position estimation is difficult because position estimation is significantly affected by circumferences such as the orientation of the mobile terminal and whether or not an obstructive object is present substantially between the mobile terminal and the access point.

In view of this, a position correction technique for solving the above-mentioned problem to improve position estimation accuracy is proposed in PTL 1. PTL 1 discloses a technique whereby, when a human body is detected by an infrared sensor installed in a facility beforehand, absolute position information and magnetic north information are transmitted to a mobile terminal of the detected user to correct position information of the mobile terminal.

However, the technique disclosed in PTL 1 is problematic in terms of cost, because equipment holding position information needs to be installed in an indoor facility.

To solve the problems described above, an aspect of the present invention has an object of providing a position estimation device, a position estimation method, and an integrated circuit capable of estimating a position of the device with high accuracy without requiring installation of special equipment indoors.

To achieve the stated object, a position estimation device according to an aspect of the present invention is a position estimation device that estimates a position of the position estimation device, the position estimation device including: a position estimation unit that estimates current position coordinates indicating a current position of the position estimation device; a pointing direction detection unit that detects a pointing direction which is a direction pointed by a user using the position estimation device; a target detection unit that detects a pointing target which is a target object pointed by the user, based on the pointing direction detected by the pointing direction detection unit; a concentration calculation unit that specifies, as a concentrated area, an area in which a position pointed in the pointing direction detected by the pointing direction detection unit in a predetermined time period immediately before the pointing target is detected by the target detection unit is included for at least a threshold time period and in which the pointing target is not present, and calculates a concentrated direction which is a direction from the position of the position estimation device in the predetermined time period to the specified concentrated area; and a position correction unit that corrects the current position coordinates using the calculated concentrated direction.

With this structure, it is possible to realize a position estimation device capable of estimating a position of the position estimation device with high accuracy without requiring installation of special equipment indoors. There is also an advantageous effect that the position estimation device can be realized at low cost because special equipment is unnecessary.

Moreover, the position correction unit may: calculate a possible area using the concentrated direction with respect to a position of the detected pointing target, the possible area being an area including coordinates at which the position estimation device is likely to be actually present when the user points to the pointing target using the position estimation device; and determine, in the calculated possible area, coordinates at which the position estimation device is actually present when the user points to the pointing target using the position estimation device and to which the current position coordinates are to be corrected, and correct the current position coordinates to the determined coordinates.

Moreover, the position estimation device may further include: an acceleration sensor; a geomagnetic sensor; a posture detection unit that detects a posture (orientation) of the position estimation device based on detection results of the acceleration sensor and the geomagnetic sensor; and a movement state detection unit that detects a movement amount based on the posture detected by the posture detection unit and the detection result of the acceleration sensor, the movement amount indicating a movement direction and a movement distance of the position estimation device, wherein the position estimation unit estimates coordinates that are away from previously estimated coordinates by the movement amount detected by the movement state detection unit, as the current position coordinates.

Moreover, the position estimation device may further include an angular velocity sensor, wherein the posture detection unit detects the posture of the position estimation device, based on an amount of change of an orientation of the position estimation device detected by the angular velocity sensor and the detection results of the acceleration sensor and the geomagnetic sensor.

Moreover, the position estimation unit may further calculate estimated position accuracy which is accuracy of the current position coordinates, based on at least one of: a distance of movement of the position estimation device from coordinates of a reference point passed by the position estimation device most recently; complexity of the movement of the position estimation device; and a time period taken for the movement of the position estimation device, wherein the position estimation device further includes an information storage unit that stores the current position coordinates estimated by the position estimation unit and the estimated position accuracy calculated by the position estimation unit, in association with each other.

Moreover, the concentration calculation unit may specify, from among a plurality of search areas of a uniform size partitioned for searching for the concentrated area, a search area including an area in which the position pointed in the pointing direction detected by the pointing direction detection unit is concentrated for at least the threshold time period, as the concentrated area, wherein the concentration calculation unit changes the size of each of the search areas, according to the current position coordinates and the estimated position accuracy stored in the information storage unit in association with each other.

Moreover, the concentration calculation unit may increase the size of each of the search areas to increase a size of the concentrated area, in the case where the estimated position accuracy associated with the current position coordinates is equal to or less than a threshold.

Moreover, the information storage unit may further store coordinates of each candidate target which is a candidate for the pointing target, and target position accuracy which is accuracy of the coordinates of the candidate target and is calculated according to a method of registering the candidate target.

Moreover, the concentration calculation unit may change a size of the concentrated area, according to the pointing target detected by the target detection unit and target position accuracy of a candidate target corresponding to the pointing target, the target position accuracy being stored in the information storage unit.

Moreover, the concentration calculation unit may increase the size of the concentrated area, in the case where the target position accuracy stored in the information storage unit is equal to or less than a threshold.

Moreover, the position correction unit may change a size of the possible area, according to the current position coordinates and the estimated position accuracy stored in the information storage unit in association with each other.

Moreover, the position correction unit may decrease the size of the possible area, in the case where the estimated position accuracy stored in the information storage unit is equal to or less than a threshold.

Moreover, the position correction unit may change a size of the possible area, according to the pointing target detected by the target detection unit and target position accuracy of a candidate target corresponding to the pointing target, the target position accuracy being stored in the information storage unit.

Moreover, the position correction unit may increase the size of the possible area, in the case where the target position accuracy stored in the information storage unit is equal to or less than a threshold.

Moreover, the position estimation device may further include a display unit that displays control information relating to the pointing target, in the case where the pointing target is detected by the target detection unit.

Moreover, the movement state detection unit may further detect a terminal movement state indicating that the position estimation device is moving, based on the detection result of the acceleration sensor, wherein the position correction unit, in the case where the terminal movement state is detected by the movement state detection unit and the pointing target is detected by the target detection unit, corrects the current position coordinates to coordinates that are away from the coordinates corrected using the calculated concentrated direction by a movement amount of the position estimation device during a time period, in the predetermined time period, from when the concentrated area is specified by the concentration calculation unit to when the pointing target is detected by the target detection unit.

The present invention may be realized no only as a device, but also as an integrated circuit including processing units included in the device, a method including steps corresponding to the processing units included in the device, or a program causing a computer to execute these steps.

The following describes an embodiment of the present invention with reference to drawings.

Note that such an overall or specific embodiment may be implemented by a system, a method, an integrated circuit, a computer program, or a computer-readable recording medium such as a CD-ROM, or any combination of a system, a method, an integrated circuit, a computer program, and a recording medium.

A position estimation device according to an aspect of the present invention is described in detail below, with reference to drawings. The embodiment described below shows one specific example of the present invention. The numerical values, shapes, materials, structural elements, the arrangement and connection of the structural elements, steps, the order of the steps etc., shown in the following embodiment are mere examples, and are not intended to limit the present invention. Furthermore, among the structural elements in the following embodiment, structural elements not recited in any of the independent claims representing the most generic concepts are described as arbitrary structural elements.

### Embodiment

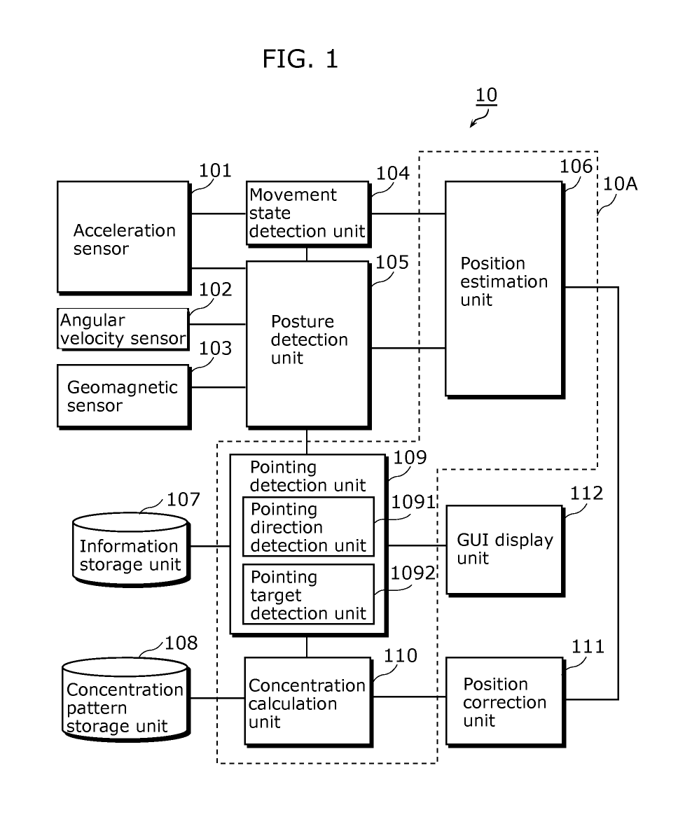

FIG. 1 is a functional block diagram of a position estimation device according to the embodiment.

A position estimation device 10 shown in FIG. 1 is fixed to, for example, a mobile terminal, and detects a position of the position estimation device 10 as a position of the mobile terminal.

The position estimation device 10 shown in FIG. 1 includes an acceleration sensor 101, an angular velocity sensor 102, a geomagnetic sensor 103, a movement state detection unit 104, a posture detection unit 105, a position estimation unit 106, an information storage unit 107, a concentration pattern storage unit 108, a pointing detection unit 109, a concentration calculation unit 110, a position correction unit 111, and a GUI display unit 112.

Since the position estimation device 10 is fixed to the mobile terminal, the states of the mobile terminal (terminal movement states) such as position, orientation, tilt, acceleration, acceleration direction, movement direction, movement distance, rotation direction, angular velocity, and the like are the same as the states of the position estimation device 10.

The acceleration sensor 101 detects a direction and a magnitude of a force such as gravity and inertial force acting on the acceleration sensor 101, in a local coordinate system (three-axis coordinate system of X, Y, and Z axes) fixed to the position estimation device 10. For example, in the case where the position estimation device 10 or the mobile terminal is shaped long in one direction, the longitudinal direction of the position estimation device 10 or the mobile terminal is the Z-axis direction, and the directions perpendicular to the Z axis and orthogonal to each other are the X-axis direction and the Y-axis direction.

The angular velocity sensor 102 detects a rotation direction and an angular velocity of the mobile terminal, at predetermined time intervals.

The geomagnetic sensor 103 detects a magnetic field strength in the local coordinate system, at predetermined time intervals. In detail, the geomagnetic sensor 103 detects a magnetic field strength in each of the X-axis direction, the Y-axis direction, and the Z-axis direction. A magnetic field (geomagnetism) in the position of the mobile terminal is expressed as one magnetic field vector, based on these magnetic field strengths of the three axes.

The movement state detection unit 104 is an example of a movement state detection unit. The movement state detection unit 104 detects (calculates) a movement amount indicating a movement direction and a movement distance of the position estimation device 10 and a terminal movement state indicating a state in which the position estimation device 10 is moving, based on an orientation (posture (posture information)) detected by the posture detection unit 105 and the detection result of the acceleration sensor 101.

In detail, the movement state detection unit 104 calculates (detects), at predetermined time intervals, a movement direction, a movement velocity, and a movement distance of the mobile terminal in a global coordinate system fixed to the earth or a home coordinate system fixed to the inside of the home, based on the posture (posture information) calculated by the posture detection unit 105 and the acceleration information outputted from the acceleration sensor 101. A parameter indicating the movement direction and the movement distance is referred to as the movement amount.

In other words, the movement state detection unit 104 analyzes the output (acceleration information) of the acceleration sensor 101, and determines whether or not the position estimation device 10 is in a movement (moving) state. Thus, the movement state detection unit 104 calculates (detects) whether or not the position estimation device 10 is in the terminal movement state. The movement state detection unit 104 also calculates (detects) the movement direction of the position estimation device 10, from the most recently accumulated output (acceleration information) of the acceleration sensor 101 and direction information by the geomagnetic sensor 103 and the like.

In this embodiment, for example, in the case where the position estimation device 10 is in the movement state, the movement state detection unit 104 calculates a movement amount from the immediately previous time when there is concentration of a position pointed in a pointing direction to the time when a pointing target is found, i.e. a movement amount between two points in time. The pointing target mentioned here is, for example, a TV, an air conditioner, or the like in the home.

The posture detection unit 105 is an example of a posture detection unit. The posture detection unit 105 detects (calculates) the posture of the position estimation device 10, based on at least the detection results of the acceleration sensor 101 and the geomagnetic sensor 103. The posture includes a tilt of the mobile terminal with respect to a horizontal plane and an orientation of the mobile terminal on the horizontal plane. In this embodiment, the posture detection unit 105 detects the posture of the position estimation device 10, based on the amount of change of the orientation of the position estimation device 10 detected by the angular velocity sensor 102 and the detection results of the acceleration sensor 101 and the geomagnetic sensor 103.

That is, the posture detection unit 105 calculates (detects), at predetermined time intervals, the posture of the mobile terminal with respect to the earth, based on the detection results of the acceleration sensor 101, the angular velocity sensor 102, and the geomagnetic sensor 103. In more detail, the posture detection unit 105 obtains the value (acceleration information) of the acceleration sensor 101, and obtains a gravity direction. The posture detection unit 105 calculates (detects) the posture (posture information) of the position estimation device 10 with respect to the horizontal plane (xy plane), from the obtained gravity direction. The posture detection unit 105 also obtains a change from a previous posture detected by the angular velocity sensor 102 or the value of the geomagnetic sensor 103, and calculates (detects) the posture (orientation) of the position estimation device 10 on the horizontal plane.

The position estimation unit 106 is an example of a position estimation unit. The position estimation unit 106 estimates current position coordinates indicating a current position of the position estimation device 10. The position estimation unit 106 also estimates the current position, from the terminal movement state and information of the current position (current position coordinates) at the time of previous estimation. In detail, the position estimation unit 106 estimates the coordinates that are away from the previously estimated coordinates by the movement amount detected by the movement state detection unit 104, as the current position coordinates. In more detail, the position estimation unit 106 calculates (estimates) the current position coordinates of the position estimation device 10 as the current position, based on the immediately previously calculated coordinates and the movement amount calculated by the movement state detection unit 104. The estimated current position coordinates are used as the immediately previously calculated coordinates when calculating the next current position coordinates. The immediately previously calculated coordinates are hereafter also referred to as immediately previous current position coordinates. For example, the position estimation unit 106 estimates the current position coordinates (X, Y, Z), based on the movement amount from the immediately previous current position coordinates (X0, Y0, Z0) at the previous estimation.

The position estimation unit 106 may further calculate estimated position accuracy which is the accuracy of the current position coordinates, based on at least one of: a distance of movement of the position estimation device 10 from coordinates of a reference point passed by the position estimation device 10 most recently; complexity of the movement of the position estimation device 10; and a time period taken for the movement of the position estimation device 10. In this case, the position estimation unit 106 stores the estimated current position coordinates and the calculated estimated position accuracy in the information storage unit 107 in association with each other.

The pointing detection unit 109 includes a pointing direction detection unit 1091 and a pointing target detection unit 1092.

The pointing direction detection unit 1091 is an example of a pointing direction detection unit. The pointing direction detection unit 1091 detects a pointing direction which is a direction pointed by the user using the position estimation device 10.

The pointing target detection unit 1092 is an example of a target detection unit. The pointing target detection unit 1092 detects a pointing target which is a target object pointed by the user, based on the pointing direction detected by the pointing direction detection unit 1091. In detail, the pointing target detection unit 1092 searches for (detects) a pointing target on an extended line in the pointing direction which is the upward (Z-axis) direction of the position estimation device 10. The pointing target mentioned here is, for example, a TV, an air conditioner, or the like in the home, as mentioned above. The pointing target is stored together with its coordinates in the information storage unit 107 beforehand, as a pointing target candidate.

The information storage unit 107 is an example of an information storage unit. The information storage unit 107 stores the current position coordinates estimated by the position estimation unit 106 and the estimated position accuracy calculated by the position estimation unit 106 in association with each other.

The information storage unit 107 also stores each candidate target which is a candidate for the pointing target, together with its coordinates. The information storage unit 107 may also store target position accuracy which is the accuracy of the coordinates of the candidate target and is calculated according to a method of registering the candidate target, together with the candidate target and its coordinates.

The concentration calculation unit 110 is an example of a concentration calculation unit. The concentration calculation unit 110 specifies, as a concentrated area, an area in which the position pointed in the pointing direction detected by the pointing direction detection unit 1091 in a predetermined time period immediately before the pointing target is detected by the pointing target detection unit 1092 is included (concentrated) for at least a threshold time period and in which the pointing target is not present. The concentrated area is a specific area that does not include the pointing target and includes the position pointed by the user in the pointing direction with at least a predetermined distribution of concentration (the concentrated area is hereafter also referred to as the specific area). The concentration calculation unit 110 then calculates a concentrated direction which is a direction from the position of the position estimation device 10 in the predetermined time period to the concentrated area (area having concentration). The predetermined time period is, for example, 3 seconds.

In other words, the concentration calculation unit 110 specifies the area (concentrated area) including the position where the pointing direction is concentrated within the predetermined time period such as 3 seconds before the time (current time) when the pointing target is detected by the pointing target detection unit 1092.

Here, from among a plurality of search areas of a uniform size partitioned for searching for the concentrated area, the concentration calculation unit 110 specifies a search area including an area in which the position pointed in the pointing direction detected by the pointing direction detection unit 1091 is concentrated for at least the threshold time period, as the concentrated area (area having concentration).

Note that the concentration calculation unit 110 may adjust the size of each search area according to the position accuracy such as the estimated position accuracy or the target position accuracy. For example, the concentration calculation unit 110 increases the size of each search area in the case where the position accuracy is low.

In detail, the concentration calculation unit 110 may change the size of each search area, according to the current position coordinates and the estimated position accuracy stored in the information storage unit 107 in association with each other. For example, in the case where the estimated position accuracy associated with the current position coordinates is equal to or less than a threshold, the concentration calculation unit 110 increases the size of each search area. In other words, in the case where the estimated position accuracy stored in the information storage unit 107 is equal to or less than the threshold, the concentration calculation unit 110 increases the size of each search area.

Moreover, the concentration calculation unit 110 may change the size of each search area, according to the pointing target detected by the pointing target detection unit 1092 and the target position accuracy of the candidate target corresponding to the pointing target stored in the information storage unit 107. For example, in the case where the target position accuracy stored in the information storage unit 107 is equal to or less than a threshold, the concentration calculation unit 110 increases the size of each search area.

The concentration pattern storage unit 108 stores information for specifying the concentrated area (area having concentration) calculated by the concentration calculation unit 110. For example, the concentration pattern storage unit 108 stores a concentration pattern for specifying the concentrated area pointed by the user with at least the predetermined distribution of concentration. The concentration pattern storage unit 108 may store the concentrated area specified by the concentration calculation unit 110 and the concentrated direction corresponding to the concentrated area.

The position correction unit 111 is an example of a position correction unit. The position correction unit 111 corrects the current position coordinates estimated by the position estimation unit 106, using the concentrated direction calculated by the concentration calculation unit 110.

Here, the position correction unit 111 calculates a possible area using the concentrated direction with respect to the position of the detected pointing target. The possible area is an area including coordinates at which the position estimation device 10 is likely to be actually present when the user points to the pointing target using the position estimation device 10. The position correction unit 111 then determines, in the calculated possible area, coordinates at which the position estimation device 10 is actually present when the user points to the pointing target using the position estimation device 10 and to which the current position coordinates are to be corrected. The position correction unit 111 corrects the current position coordinates to the determined coordinates.

In more detail, through the use of the direction (concentrated direction) from the current position of the position estimation device 10 at the time of concentration to the calculated concentrated area, the position correction unit 111 calculates, as the possible area, an area of a predetermined width on a straight line that is in an opposite direction to the concentrated direction and extends from a current position of a provisional pointing target on an assumption that the provisional pointing target is placed in a logical space. That is, the position correction unit 111 defines the area (possible area) in which the information (current position coordinates) of the current position of the mobile terminal is likely to be present, with respect to the position (for example, coordinates (X2, Y2, Z2)) of the pointing target. The position correction unit 111 then determines, as the coordinates to which the current position coordinates (current position) are to be corrected, the coordinates in the calculated possible area that are closest to the current position coordinates, and corrects the current position coordinates to the closest coordinates. Though the position correction unit 111 corrects the current position coordinates (current position) to the coordinates in the calculated possible area that are closest to the current position coordinates, this is not a limit for the present invention. The position correction unit 111 may correct the current position coordinates to the center of the calculated possible area.

Note that the position correction unit 111 may adjust the width (size) of the possible area according to the position accuracy such as the estimated position accuracy or the target position accuracy.

In detail, the position correction unit 111 may change the width (size) of the possible area, according to the current position coordinates and the estimated position accuracy stored in the information storage unit 107 in association with each other. For example, in the case where the estimated position accuracy associated with the current position coordinates is equal to or less than a threshold, the position correction unit 111 decreases the width (size) of the possible area. In other words, in the case where the estimated position accuracy stored in the information storage unit 107 is equal to or less than the threshold, the position correction unit 111 decreases the width (size) of the possible area.

Thus, in the case where the estimated position accuracy is low, the position correction unit 111 decreases the width (size) of the possible area so that the position is corrected to a greater extent.

Moreover, the position correction unit 111 may change the width (size) of the possible area, according to the pointing target detected by the pointing target detection unit 1092 and the target position accuracy of the candidate target corresponding to the pointing target stored in the information storage unit 107. For example, in the case where the target position accuracy stored in the information storage unit 107 is equal to or less than a threshold, the position correction unit 111 increases the width (size) of the possible area.

Thus, the position correction unit 111 increases the width (size) of the possible area in the case where the target position accuracy is low. That is, in the case where the target position accuracy is low, the position estimation device 10 increases the width (size) of the possible area so that the position is corrected to a lesser extent.

Though the above describes the case where the position estimation device 10 is not in the movement state, the present invention is not limited to this. Since the mobile terminal including the position estimation device 10 can be carried by the user, the user may point to the pointing target while moving. In such a case, the position correction unit 111 may be configured as follows.

In the case where the terminal movement state is detected and also the pointing target is detected by the pointing target detection unit 1092, the position correction unit 111 corrects the current position coordinates by taking into consideration the movement amount of the position estimation device 10. In detail, the position correction unit 111 corrects the current position coordinates to coordinates that are away from the coordinates corrected using the calculated concentrated direction by the movement amount of the position estimation device 10 during a time period, in the predetermined time period, from when the concentrated area of the pointing direction is specified by the concentration calculation unit 110 to when the pointing target is detected by the pointing target detection unit 1092.

The GUI display unit 112 is an example of a display unit. The GUI display unit 112 displays control information relating to the pointing target, in the case where the pointing target is detected by the pointing target detection unit 1092. For example, the control information relating to the pointing target is a GUI (Graphical User Interface) screen such as a remote control screen for control, and user interface information (UI information).

The position estimation device 10 has the structure described above.

With this structure, the position of the position estimation device 10 can be estimated with high accuracy without requiring installation of special equipment, such as a dedicated antenna of indoor GPS, indoors.

Note that the position estimation device 10 does not necessarily need to include the information storage unit 107. Necessary information may be obtained from a cloud or the like on a network accessible by the mobile terminal including the position estimation device 10.

The following describes characteristic operations of the position estimation device 10 according to the embodiment. In detail, an example of a method whereby, in the case of determining that the estimated current position information (current position coordinates) has an error, the position estimation device 10 corrects the current position information (current position coordinates) is described below.

Consider the following situation, as an example. The user points, using the position estimation device 10, to a pointing target such as a TV which the user is actually seeing, but the pointing target is not detected at once. The user then randomly shakes the top end of the position estimation device 10, as a result of which the pointing target is detected. In the following description, the term “mobile terminal” actually held by the user is used based on an assumption that the position estimation device 10 is included in the mobile terminal.

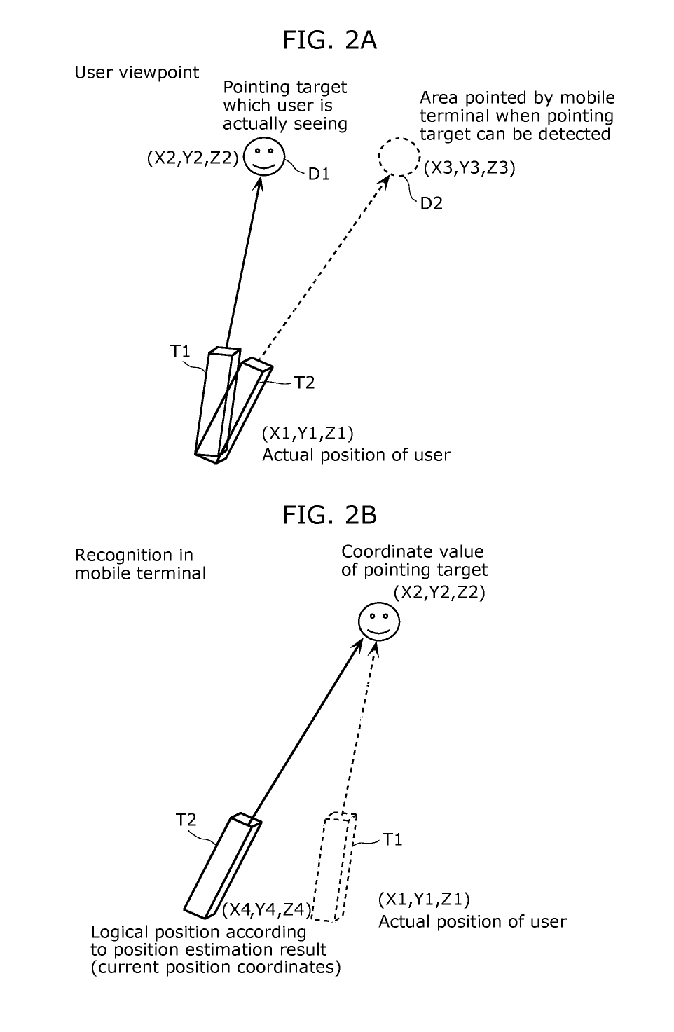

FIGS. 2A and 2B are diagrams showing a difference between positional relationships recognized by the user and the mobile terminal for the pointing target, in the above situation. FIG. 2A shows the positional relationship recognized by the user, while FIG. 2B shows the positional relationship recognized by the mobile terminal.

In FIG. 2A, first the user points the mobile terminal to a pointing target D1 (coordinates (X2, Y2, Z2)) which the user is actually seeing, in the upward direction (as shown by T1) in FIG. 2A. If the current position information (current position coordinates) of the mobile terminal held by the user is accurate, the pointing target D1 is detected at once and control information associated with the pointing target D1 is displayed. If the current position information (current position coordinates) of the mobile terminal has deviation (error), on the other hand, the mobile terminal is unable to detect the pointing target D1. FIG. 2A shows the case where the current position information of the mobile terminal has deviation. That is, even when the user points the mobile terminal to the pointing target D1 (like the mobile terminal T1), the mobile terminal cannot detect the pointing target D1 because of an error in the current position information of the mobile terminal.

Next, the user points the mobile terminal to near the pointing target D1 pointed once. In detail, the user changes the pointing direction by randomly shaking the top of the mobile terminal or the like so that the mobile terminal can detect the pointing target.

As a result, the mobile terminal detects the pointing target D1 when pointed to a position D2 (coordinates (X3, Y3, Z3)) where the pointing target D1 is actually not present, as shown by T2 in FIG. 2A. This can be explained as follows, from the viewpoint of the mobile terminal shown in FIG. 2B. Not the coordinates (X1, Y1, Z1) where the user is actually present but the coordinates (X4, Y4, Z4) are estimated as the current position information (current position coordinates) of the mobile terminal. Accordingly, when the user points the mobile terminal as shown by T2 in FIG. 2B, the mobile terminal detects the pointing target D1 on an extended line in the pointing direction.

That is, despite the coordinates (X1, Y1, Z1) being the actual position of the user, the coordinates (X4, Y4, Z4) are estimated as the current position information (current position coordinates) by the mobile terminal. Therefore, the pointing target D1 cannot be detected even when the user points the mobile terminal to the actually seen pointing target D1 (coordinates (X2, Y2, Z2)).

The following describes a method whereby the mobile terminal including the position estimation device 10 determines whether or not the estimated current position information (current position coordinates) has an error, in the situation shown in FIGS. 2A and 2B.

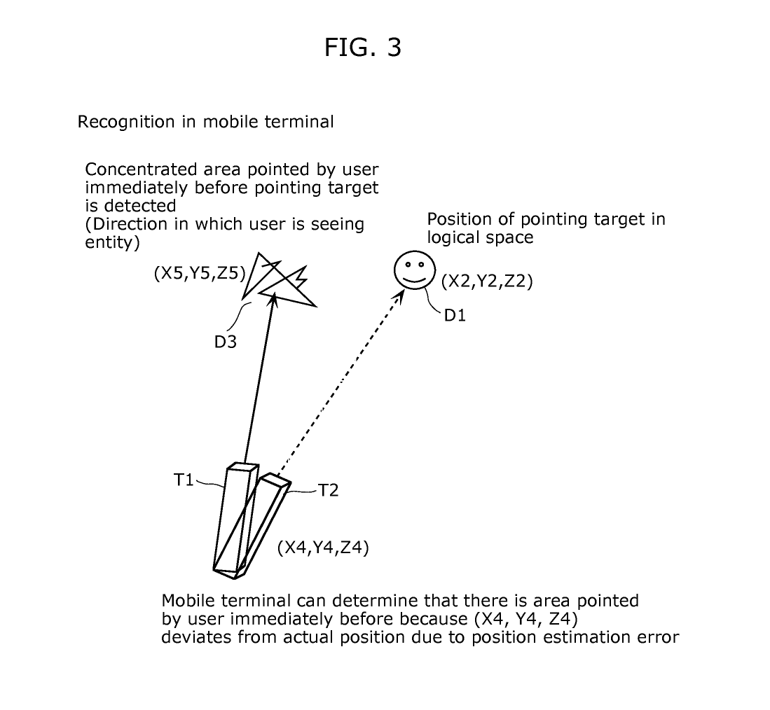

FIG. 3 is a diagram for describing an example of the method whereby the mobile terminal determines whether or not the estimated current position information (current position coordinates) has an error. The coordinates based on the current position information (current position coordinates) estimated by the mobile terminal are shown in FIG. 3.

As shown in FIG. 3, upon detecting the pointing target D1 when the mobile terminal is pointed as shown by T2 in FIG. 3, the mobile terminal calculates whether or not there is a concentrated area in which the position pointed by the user in the pointing direction immediately before the pointing target D1 is detected is included for at least the threshold time period and in which the pointing target D1 is not present. The concentrated area includes an area including the position pointed by the user and having predetermined concentration of the position pointed by the user. Note that the concentrated area is an area in a direction in which the user is actually seeing the entity.

Once determining that there is the concentrated area, the mobile terminal can determine that the current position information (current position coordinates) of the mobile terminal has deviation. This is because, in the case where the coordinates (X4, Y4, Z4) which are the current position information (current position coordinates) estimated by the mobile terminal when the pointing target D1 is actually detected deviate from the actual current position coordinates (X1, Y1, Z1), there is a high likelihood that the user pointed to the area different from the position of the pointing target D1. Thus, the mobile terminal can determine that the current position information (current position coordinates) of the mobile terminal has deviation as a result of determining that there is the concentrated area.

The following describes a method whereby, in the case of determining that the estimated current position information (current position coordinates) has an error, the mobile terminal corrects the current position information (current position coordinates), with reference to drawings.

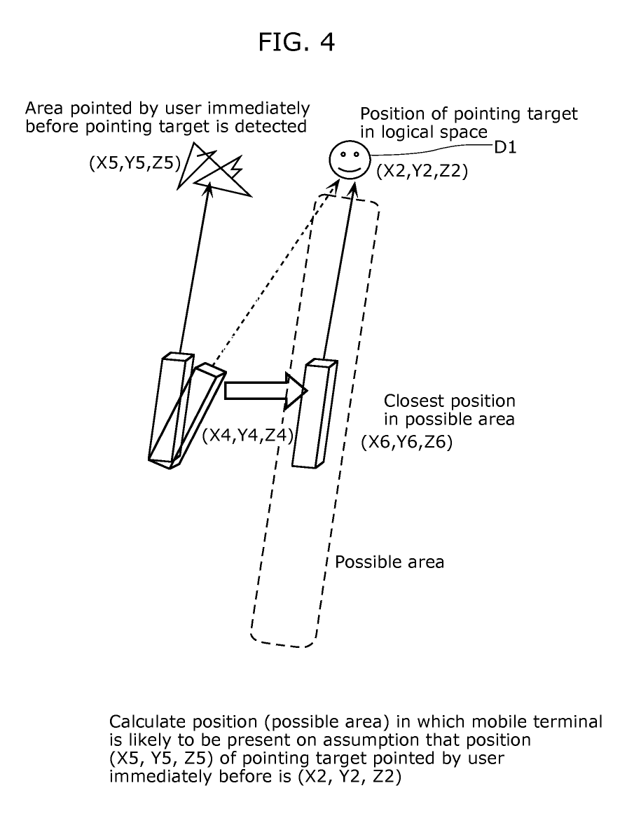

FIG. 4 is a diagram for describing an example of the method whereby, in the case of determining that the estimated current position information has an error, the mobile terminal corrects the current position information. The coordinates based on the current position information (current position coordinates) estimated by the mobile terminal are shown in FIG. 4, too.

First, the mobile terminal assumes that the position (coordinates (X5, Y5, Z5)) pointed by the user immediately before is the position (coordinates (X2, Y2, Z2)) of the pointing target D1. The mobile terminal defines an area (possible area) in which the current position information (current position coordinates) of the mobile terminal is likely to be present, with respect to the position (coordinates (X2, Y2, Z2)) of the pointing target. In detail, the mobile terminal translates the direction (direction information) from the current position information (current position coordinates (X4, Y4, Z4)) estimated when the position of the pointing target D1 is detected to the position (coordinates (X5, Y5, Z5)) pointed by the user immediately before, so as to cross the position (coordinates (X2, Y2, Z2)) of the pointing target D1. The mobile terminal then calculates an area of a predetermined width centering on a straight line that extends from the position (coordinates (X2, Y2, Z2)) of the pointing target D1 in a direction opposite to the above-mentioned direction, as the possible area.

The mobile terminal then corrects the current position coordinates (current position) to the coordinates in the calculated possible area that are closest to the current position coordinates. Thus, the mobile terminal can correct the error of the estimated current position coordinates through the user's operation, with it being possible to improve the accuracy of the estimated current position coordinates. Though the mobile terminal corrects the current position coordinates (current position) to the coordinates in the calculated possible area that are closest to the current position coordinates, this is not a limit for the present invention. The mobile terminal may correct the current position coordinates to the center of the calculated possible area, as mentioned above.

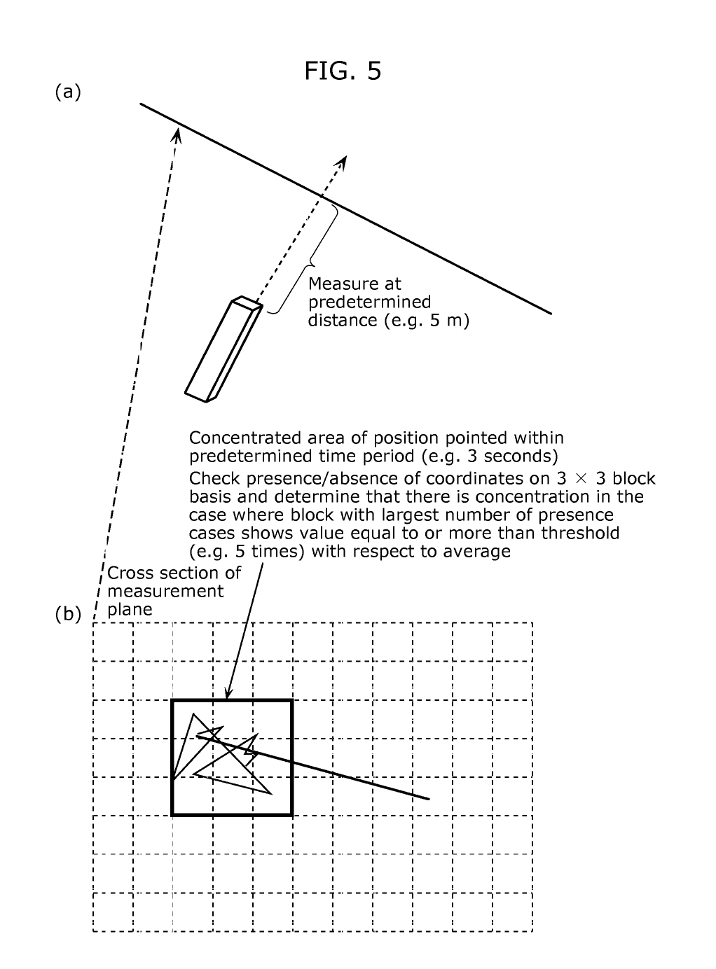

The following describes a method whereby the mobile terminal calculates whether or not there is a concentrated area of the pointing direction pointed by the user immediately before the pointing target D1 is detected, with reference to FIG. 5.

FIG. 5 is a diagram for describing an example of the method whereby the mobile terminal determines whether or not there is a concentrated area of the pointing direction.

The determination of whether or not the pointing direction is concentrated in a specific area depends on the distance between the mobile terminal and a plane including the area.

In this embodiment, as shown in (a) in FIG. 5 as an example, a logical plane (measurement plane) is set at a predetermined distance such as 5 m from the mobile terminal, centering on the pointing direction of the mobile terminal. The mobile terminal divides the measurement plane into blocks of a uniform size, as shown in (b) in FIG. 5. For example, the measurement plane may be divided into blocks of 50 cm square.

Through the use of the measurement plane, the mobile terminal determines whether or not there is a concentrated area among areas including the position pointed within a predetermined time period such as 3 seconds, as mentioned above. For example, in the case of determining the concentrated area using the measurement plane, the mobile terminal measures the coordinates intersecting with the pointing direction on a 3×3 block basis (search area basis), and calculates the trace (positions) of the coordinates intersecting with the pointing direction. The mobile terminal can then determine a block (search area) in which the trace (positions) of the coordinates intersecting with the pointing direction is equal to or more than a threshold (e.g. 5 times) with respect to an average and also the trace (positions) is largest in number, as the concentrated area.

In the case where the trace (positions) of the coordinates intersecting with the pointing direction is less than the threshold (e.g. 5 times) with respect to the average, the mobile terminal determines that there is no concentrated area.

The mobile terminal may adjust the size of each search area according to the position accuracy such as the estimated position accuracy or the target position accuracy. For example, the mobile terminal may increase the size of each search area from 3×3 blocks to 5×5 blocks, in the case where the position accuracy is low.

In this way, the position estimation device 10 determines that the estimated current position information (current position coordinates) has an error, and corrects the current position information (current position coordinates).

Though the above describes the case where the position estimation device 10 is not in the movement state, the present invention is not limited to this. Since the mobile terminal including the position estimation device 10 can be carried by the user, the user may point to the pointing target while moving. The following describes an example of a method of determining that the estimated current position information (current position coordinates) has an error and correcting the current position information (current position coordinates) in the case where the position estimation device 10 is in the movement state.

The situation considered here is the same as that in FIGS. 2A and 2B, but differs in that the mobile terminal moves from when the user points, using the position estimation device 10, to the pointing target which the user is actually seeing to when the pointing target is detected in the case where the user randomly shakes the top end of the position estimation device 10 from side to side.

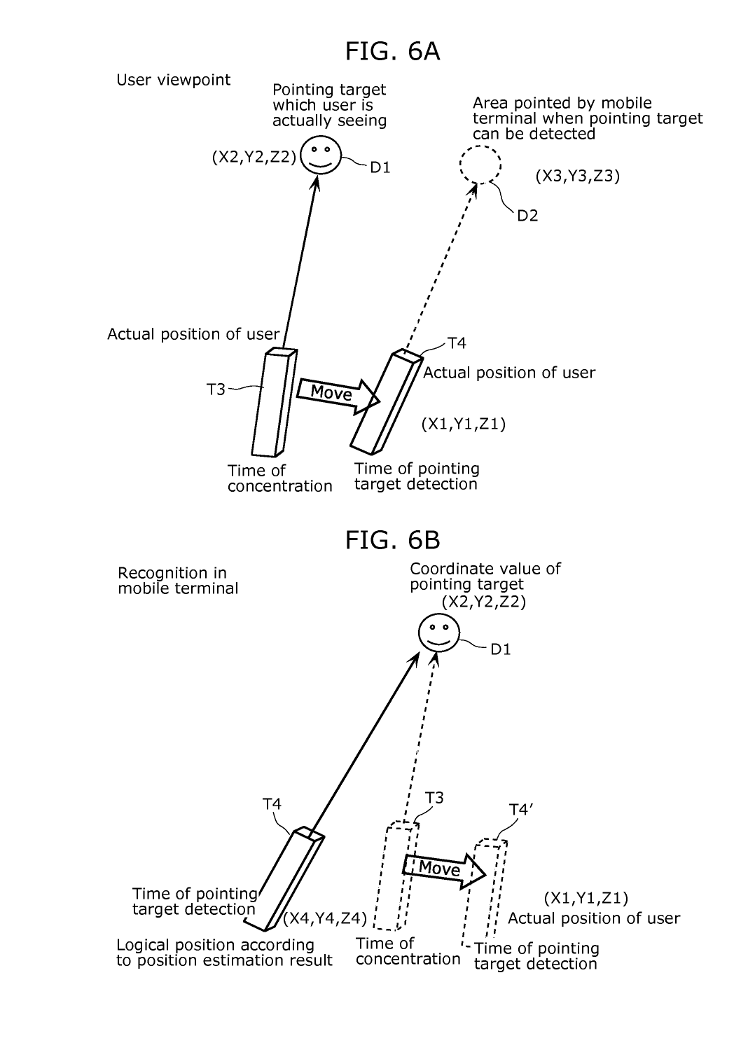

FIGS. 6A and 6B are diagrams showing a difference between positional relationships recognized by the user and the mobile terminal for the pointing target, in the above situation. FIG. 6A shows the positional relationship recognized by the user, while FIG. 6B shows the positional relationship recognized by the mobile terminal.

In FIG. 6A, first the user points the mobile terminal to the pointing target D1 (coordinates (X2, Y2, Z2)) which the user is actually seeing, in the upward direction (as shown by T3) in FIG. 6A. FIG. 6A shows the case where the current position information of the mobile terminal has deviation, as in FIG. 2A. That is, even when the user points the mobile terminal to the pointing target D1 (like the mobile terminal T1), the mobile terminal cannot detect the pointing target D1 because of an error in the current position information of the mobile terminal.

Next, the user points the mobile terminal to near the pointing target D1 pointed once. In detail, the user changes the pointing direction by randomly shaking the top of the mobile terminal or the like so that the mobile terminal can detect the pointing target D1. During this time, for example, the user (mobile terminal) is moving.

The mobile terminal detects the pointing target D1 when pointed to the position D2 (coordinates (X3, Y3, Z3)) where the pointing target D1 is actually not present, as shown by T4 in FIG. 6A. This can be explained as follows, from the viewpoint of the mobile terminal shown in FIG. 6B. Not the coordinates (X1, Y1, Z1) where the user is actually present after the movement but the coordinates (X4, Y4, Z4) are estimated as the current position information (current position coordinates) of the mobile terminal when the position of the pointing target D1 is detected. Accordingly, when the user points the mobile terminal as shown by T4 in FIG. 6B (or FIG. 6A), the mobile terminal detects the pointing target D1 on an extended line in the pointing direction.

That is, despite the coordinates (X1, Y1, Z1) being the actual position of the user when the pointing target D1 is detected by the mobile terminal, the coordinates (X4, Y4, Z4) are estimated as the current position information (current position coordinates) by the mobile terminal when the pointing target is detected by the mobile terminal, as shown by T4 in FIG. 6B. Therefore, the pointing target D1 cannot be detected even when the user points the mobile terminal to the actually seen pointing target D1 (coordinates (X2, Y2, Z2)). In other words, the user points the mobile terminal as shown by T3 in FIG. 6B and, after the certain movement, points the mobile terminal as shown by T4′ in FIG. 6B. At this time, the mobile terminal detects the pointing target, at the coordinates (X4, Y4, Z4) which are the estimated current position information (current position coordinates).

The following describes a method whereby, in the case of determining that the estimated current position information (current position coordinates) has an error, the mobile terminal corrects the current position information (current position coordinates), with reference to drawings. Since the method whereby the mobile terminal determines whether or not the estimated current position information (current position coordinates) has an error is the same as in FIG. 3, its description is omitted.

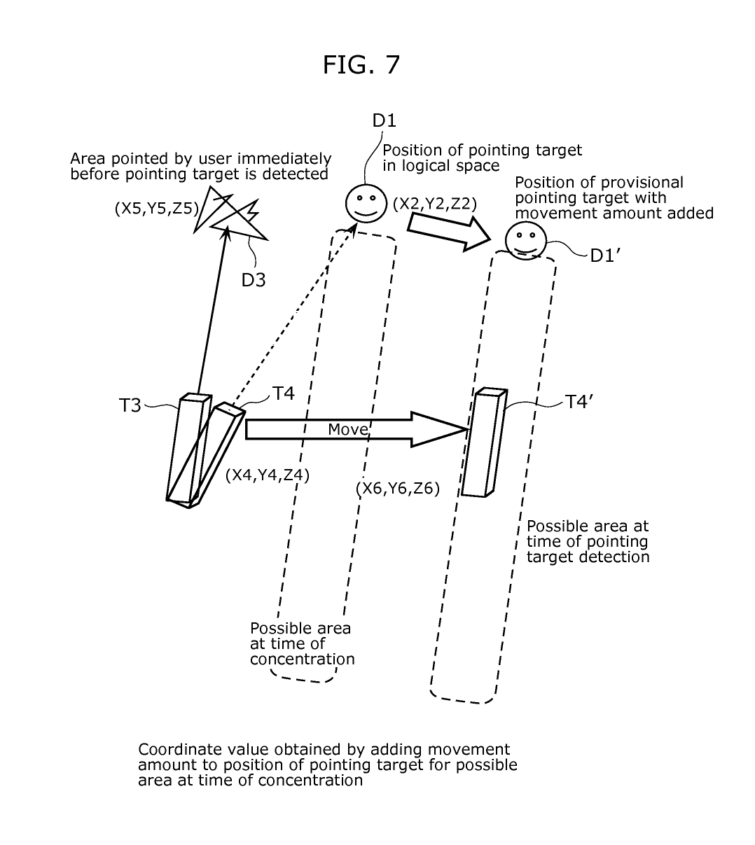

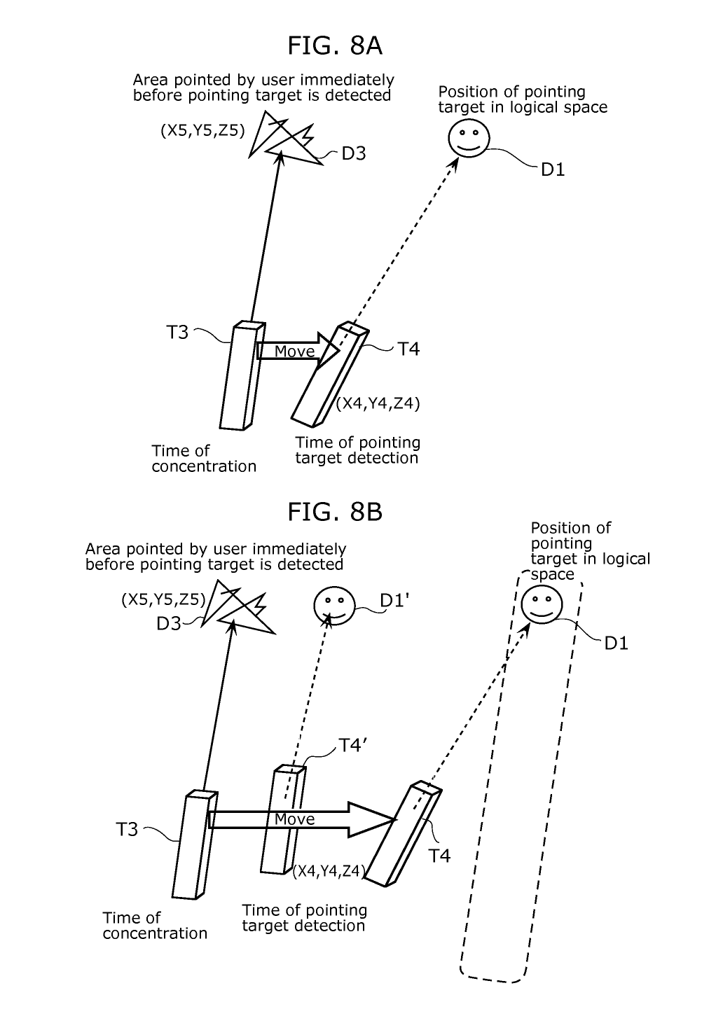

FIGS. 7, 8A, and 8B are diagrams for describing an example of the method whereby, in the case of determining that the estimated current position information has an error, the mobile terminal corrects the current position information. The coordinates based on the current position information (current position coordinates) estimated by the mobile terminal are shown in FIGS. 7, 8A, and 8B.

As shown in FIG. 7, first the mobile terminal defines the possible area based on the time of concentration, in the same way as in FIG. 4. After this, the movement state detection unit 104 calculates the movement amount of the mobile terminal from when there is concentration of the pointing direction immediately before to when the pointing target D1 is detected. The position estimation unit 106 moves the possible area by the movement amount of the mobile terminal calculated by the movement state detection unit 104.

The mobile terminal then corrects the current position coordinates (current position) to the position in the calculated possible area that is closest to the current position coordinates (current position). Thus, the mobile terminal can correct the error of the estimated current position coordinates through the user's operation even when moving, with it being possible to improve the accuracy of the estimated current position coordinates.

In this way, the position correction can be carried out without installation of special equipment indoors.

FIG. 8A is the same as FIG. 6A, but differs in that the position D2 in FIG. 6A is replaced with the recognition by the mobile terminal. That is, in FIG. 8A, the position D2 in FIG. 6A is shown as a position D3 (coordinates (X5, Y5, Z5)) which is a concentrated position pointed by the user in the predetermined time period immediately before the pointing target D1 is detected and in which the pointing target D1 is actually not present. In addition, the current position information (current position coordinates) at the time (T4) when the mobile terminal detects the pointing target D1 is shown as the coordinates (X4, Y4, Z4).

Here, the mobile terminal moves from when the position D3 which is the concentrated area is pointed to when the pointing target D1 is actually detected. Accordingly, while taking into consideration the movement amount of the mobile terminal, the mobile terminal defines the area (possible area) in which the current position information (current position coordinates) of the mobile terminal is likely to be present, with respect to the position (coordinates (X2, Y2, Z2)) of the pointing target D1, as shown in FIG. 8B.

In detail, as shown in FIG. 7, the mobile terminal first specifies a position of a provisional pointing target D1′, by adding the movement amount to the pointing target D1 (coordinates (X2, Y2, Z2)). The mobile terminal then translates the direction (direction information) from the current position information (current position coordinates (X5, Y5, Z5)) to the concentrated position D3 pointed by the user immediately before the pointing target D1 is detected, so as to cross the provisional pointing target D1′. The mobile terminal calculates an area of a predetermined width centering on a straight line that extends from the position of the provisional pointing target D1′ in a direction opposite to the above-mentioned direction, as the possible area.

The mobile terminal then corrects the current position coordinates (current position) to the coordinates in the calculated possible area that are closest to the current position coordinates.

Thus, the mobile terminal can correct the error of the estimated current position coordinates through the user's operation, with it being possible to improve the accuracy of the estimated current position coordinates.

Though the mobile terminal corrects the current position coordinates (current position) to the coordinates in the calculated possible area that are closest to the current position coordinates, this is not a limit for the present invention. The mobile terminal may correct the current position coordinates to the center of the calculated possible area, as mentioned above.

The following describes process flow of the mobile terminal, with reference to drawings.

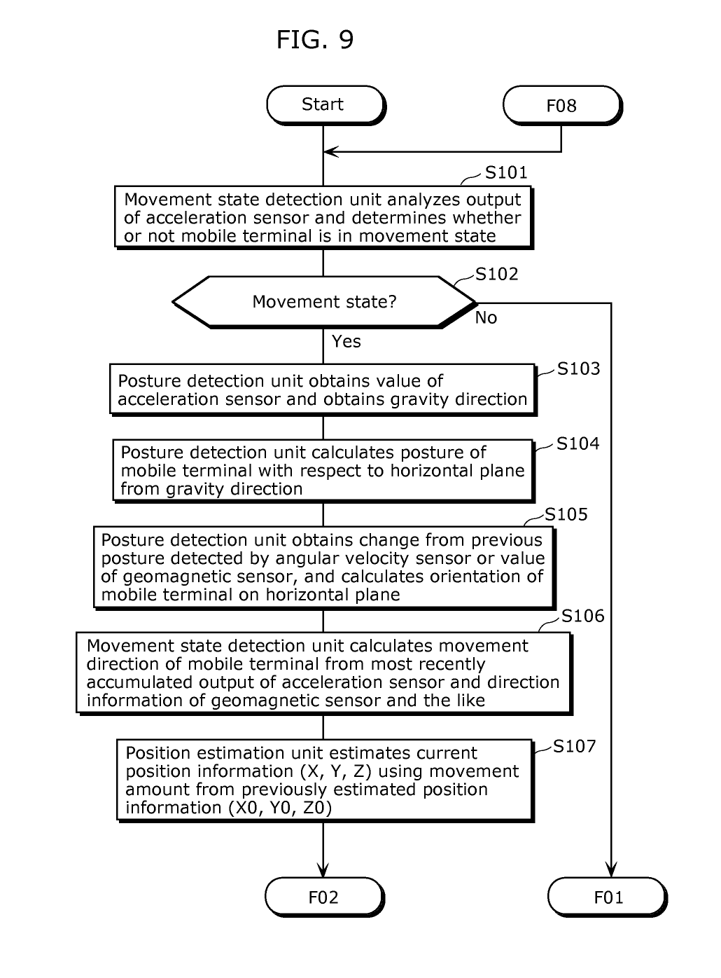

FIGS. 9 to 14 are flowcharts for describing process flow of the mobile terminal.

The process shown in FIG. 9 is described first. FIG. 9 shows process flow up to when the mobile terminal estimates the current position information (current position coordinates).

In FIG. 9, first the movement state detection unit 104 analyzes the output (acceleration information) of the acceleration sensor 101, and determines whether or not the mobile terminal is in the movement state (Step S101).

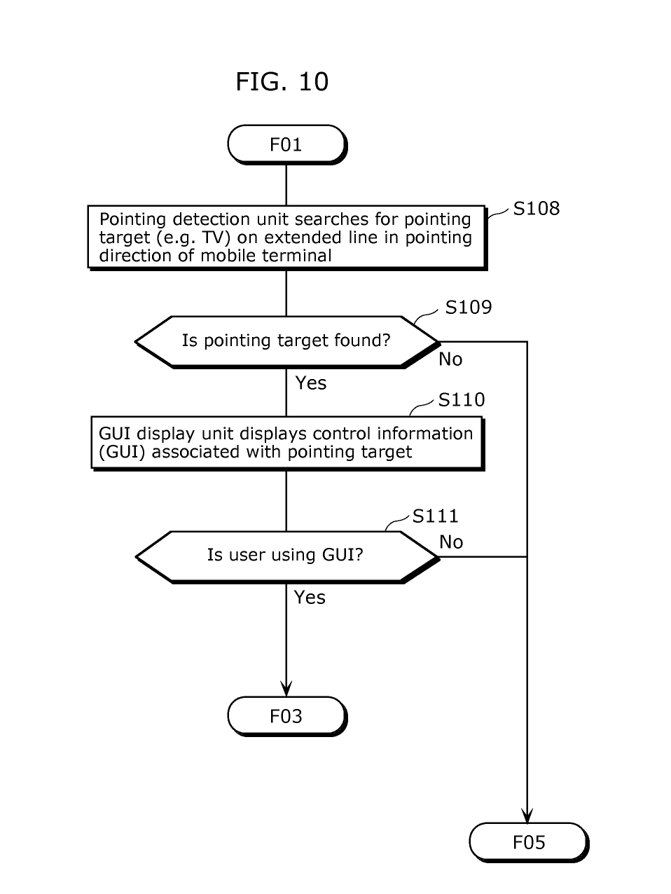

In the case where the movement state detection unit 104 determines that the mobile terminal is not in the movement state (terminal movement state) (Step S102: No), the mobile terminal proceeds to F01 in FIG. 10.

In the case where the movement state detection unit 104 determines that the mobile terminal is in the movement state (terminal movement state) (Step S102: Yes), the posture detection unit 105 obtains the value of the acceleration sensor 101, and obtains the gravity direction (Step S103).

Next, the posture detection unit 105 calculates the posture (posture information) of the mobile terminal with respect to the horizontal plane, from the obtained gravity direction (Step S104).

Next, the posture detection unit 105 obtains the change from the previous posture detected by the angular velocity sensor 102 or the value of the geomagnetic sensor 103, and calculates the orientation of the mobile terminal on the horizontal plane (Step S105).

Next, the movement state detection unit 104 calculates the movement direction of the mobile terminal from the most recently accumulated output of the acceleration sensor 101 and direction information by the geomagnetic sensor 103 and the like (Step S106).

The position estimation unit 106 then estimates the current position information (coordinates (X, Y, Z)), using the movement amount from the previously estimated current position information (e.g. the previously estimated current position coordinates (X0, Y0, Z0)) (Step S107).

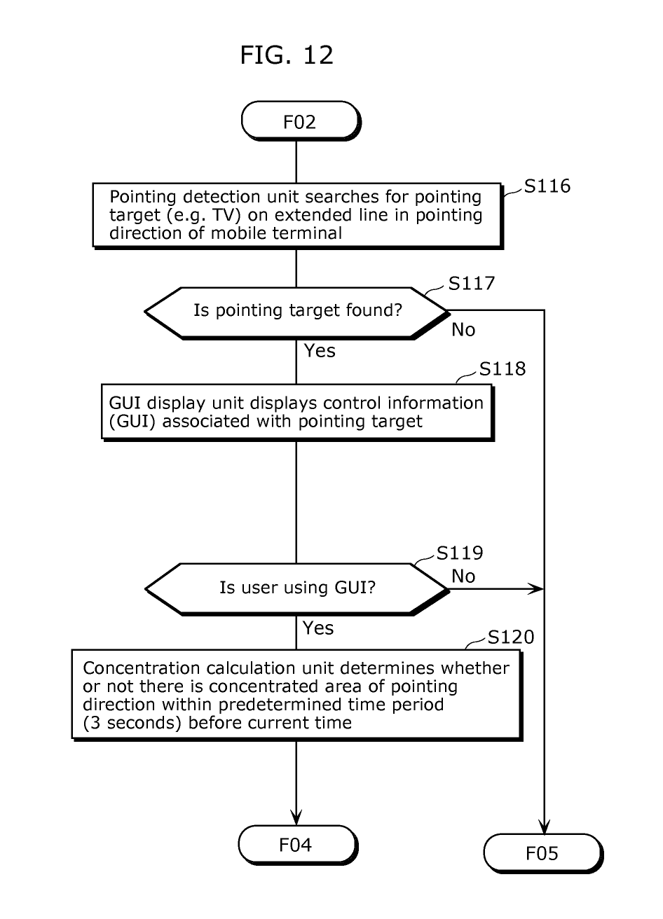

The mobile terminal then proceeds to F02 in FIG. 12.

The process shown in FIG. 10 is described next. FIG. 10 shows process flow in which the mobile terminal detects a pointing target.

In FIG. 10, first the pointing detection unit 109 searches for (detects) a pointing target such as a TV on an extended line in the pointing direction of the mobile terminal (Step S108). In detail, in the case where the movement state detection unit 104 determines that the mobile terminal is not in the movement state in Step S102 in FIG. 9 (Step S102: No), the pointing direction detection unit 1091 detects the pointing direction which is the direction pointed by the user using the mobile terminal. Following this, the pointing target detection unit 1092 searches for (detects) a pointing target on the extended line in the pointing direction of the mobile terminal.

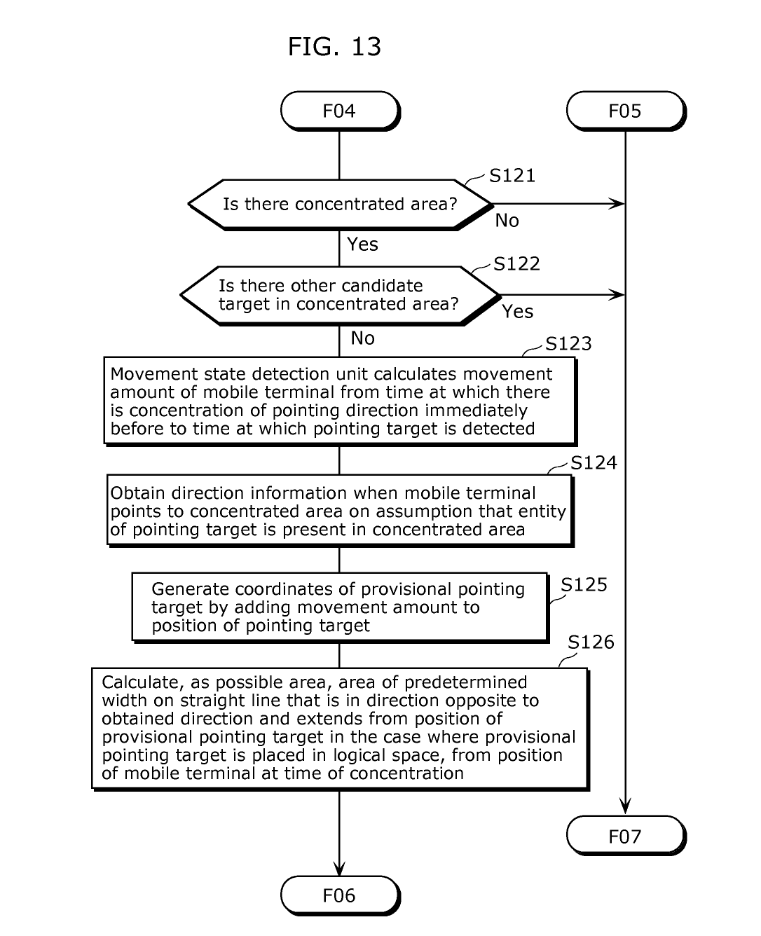

In the case where the pointing target detection unit 1092 does not detect the pointing target (Step S109: Yes), the mobile terminal proceeds to F05 in FIG. 13.

In the case where the pointing target detection unit 1092 detects the pointing target (Step S109: Yes), the GUI display unit 112 displays control information, e.g. a GUI such as a remote control screen, associated with the pointing target (Step S110).

The GUI display unit 112 then determines whether or not the user is using the control information (Step S111). In the case where the GUI display unit 112 determines that the user is not using the control information (GUI) (Step S111: No), the mobile terminal proceeds to F05 in FIG. 13.

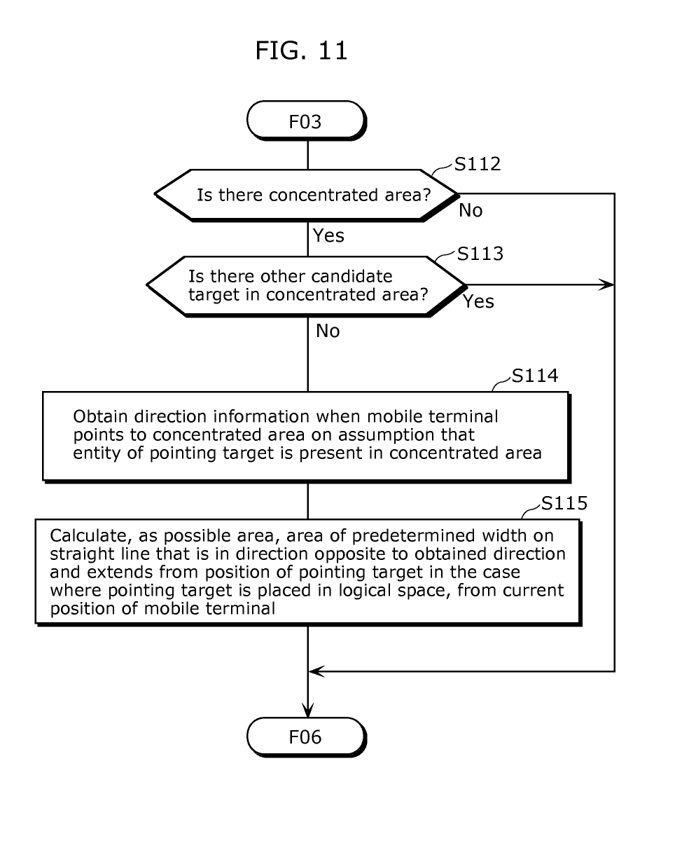

In the case where the GUI display unit 112 determines that the user is using the control information (GUI) (Step S111: Yes), the mobile terminal proceeds to F03 in FIG. 11.

The process shown in FIG. 11 is described next. FIG. 11 shows process flow up to when the mobile terminal corrects (modifies) the estimated current position information (current position coordinates) using a concentrated area.

In FIG. 11, first the concentration calculation unit 110 determines whether or not there is a concentrated area (Step S112). In detail, in the case where the GUI display unit 112 determines that the user is using the control information (GUI) in Step S111 (Step S111: Yes), the concentration calculation unit 110 determines whether or not an area in which the pointing target is not present and in which the position pointed in the pointing direction detected by the pointing direction detection unit 1091 in the predetermined time period immediately before the pointing target is detected by the pointing target detection unit 1092 is included for at least the threshold time period can be specified as a concentrated area.

Here, the concentration calculation unit 110 may determine whether or not there is a concentrated area, without being triggered by the determination by the GUI display unit 112 as to whether or not the user is using the control information (GUI).

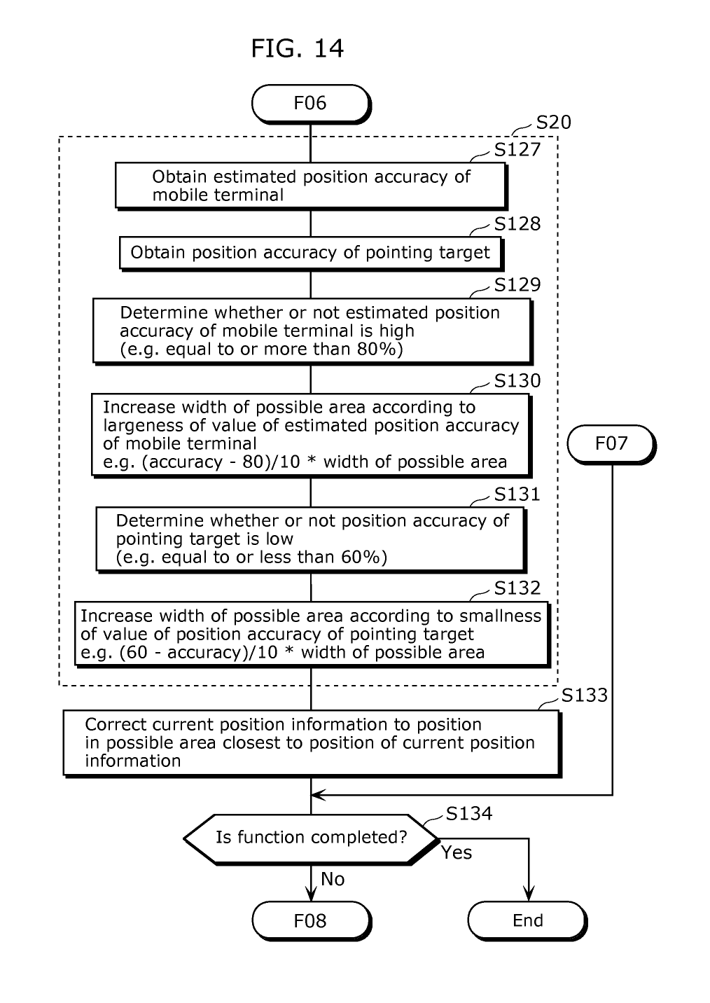

In the case where the concentration calculation unit 110 does not find the concentrated area in Step S112 (Step S112: No), the mobile terminal proceeds to F06 in FIG. 14.

In the case where the concentration calculation unit 110 finds the concentrated area in Step S112 (Step S112: Yes), the pointing target detection unit 1092 determines whether or not a candidate target different from the pointing target desired by the user is present in the concentrated area (Step S113).

In the case where the pointing target detection unit 1092 detects a candidate target different from the pointing target desired by the user in the concentrated area in Step S113 (Step S113: Yes), the mobile terminal proceeds to F06 in FIG. 14.

In the case where the pointing target detection unit 1092 detects no candidate target different from the pointing target desired by the user in the concentrated area in Step S113 (Step S113: No), the mobile terminal proceeds to Step S114. The movement state detection unit 104 assumes that the entity of the pointing target is present in the concentrated area, and obtains the direction information at the time when the mobile terminal points to the concentrated area (Step S114).

The direction information is, for example, the direction of the coordinates of D3 with respect to the coordinates of the mobile terminal in FIG. 3.

Next, regarding the direction indicated by the obtained direction information from the current position of the mobile terminal, the position correction unit 111 calculates an area of a predetermined width on a straight line that is in a direction opposite to the above-mentioned direction and extends from the position of the pointing target in the case where the pointing target is placed in a logical space, as a possible area (Step S115).

The mobile terminal then proceeds to F06 in FIG. 14.

The process shown in FIG. 12 is described next. FIG. 12 shows process flow in which the mobile terminal detects the pointing target.

In FIG. 12, first the pointing direction detection unit 1091 searches for (detects) a pointing target such as a TV on an extended line in the pointing direction of the mobile terminal (Step S116).

Following this, the pointing target detection unit 1092 determines whether or not the pointing target is found (Step S117).

In the case where the pointing target detection unit 1092 determines that the pointing target is not found (Step S117: No), the mobile terminal proceeds to F05 in FIG. 13.

In the case where the pointing target detection unit 1092 determines that the pointing target is found (Step S117: Yes), the GUI display unit 112 displays control information associated with the pointing target (Step S118). The control information mentioned here is a GUI such as a remote control screen, as an example.

The GUI display unit 112 then determines whether or not the user is using the GUI (Step S119).

In the case where the GUI display unit 112 determines that the user is not using the GUI (Step S119: No), the mobile terminal proceeds to F05 in FIG. 13.

In the case where the GUI display unit 112 determines that the user is using the GUI (Step S119: Yes), the concentration calculation unit 110 determines whether or not there is a concentrated area of the pointing direction within the predetermined time period (3 seconds) before the current time (Step S120).

That is, the concentration calculation unit 110 determines whether or not an area in which the pointing target is not present and in which the position pointed in the pointing direction detected by the pointing direction detection unit 1091 in the predetermined time period immediately before the pointing target is detected by the pointing target detection unit 1092 is included for at least the threshold time period can be specified as a concentrated area.

The mobile terminal then proceeds to F04 in FIG. 13.

The process shown in FIG. 13 is described next. FIG. 13 shows process flow in which the mobile terminal detects the pointing target while the mobile terminal is in the movement state (the mobile terminal is moving).

In FIG. 13, first the concentration calculation unit 110 determines whether or not there is a concentrated area (Step S121). In detail, in the case where the GUI display unit 112 determines that the user is using the control information (GUI) (Step S119: Yes), the concentration calculation unit 110 determines whether or not an area in which the pointing target is not present and in which the position pointed in the pointing direction detected by the pointing direction detection unit 1091 in the predetermined time period immediately before the pointing target is detected by the pointing target detection unit 1092 is included for at least the threshold time period can be specified as a concentrated area, in Step S121.

Here, the concentration calculation unit 110 may determine whether or not there is a concentrated area, without being triggered by the determination by the GUI display unit 112 as to whether or not the user is using the control information (GUI).

In the case where the concentration calculation unit 110 does not find the concentrated area in Step S121 (Step S121: No), the mobile terminal proceeds to F07 in FIG. 14.

In the case where the concentration calculation unit 110 finds the concentrated area in Step S121 (Step S121: Yes), the pointing target detection unit 1092 determines whether or not a candidate target different from the pointing target desired by the user is present in the concentrated area (Step S122).

In the case where the pointing target detection unit 1092 detects a candidate target different from the pointing target desired by the user in the concentrated area in Step S122 (Step S122: Yes), the mobile terminal proceeds to F07 in FIG. 14.

In the case where the pointing target detection unit 1092 detects no candidate target different from the pointing target desired by the user in the concentrated area in Step S122 (Step S122: No), the mobile terminal proceeds to Step S123. The movement state detection unit 104 calculates the movement amount of the mobile terminal from when there is concentration of the pointing direction immediately before to when the pointing target is detected (Step S123).

The movement state detection unit 104 then assumes that the entity of the pointing target is present in the concentrated area, and obtains the direction information at the time when the mobile terminal points to the concentrated area (Step S124).

Next, the position correction unit 111 generates coordinates of a provisional pointing target, by adding the movement amount to the position of the pointing target (Step S125).

Next, regarding the obtained direction from the position of the mobile terminal at the time of concentration, the position correction unit 111 calculates an area of a predetermined width on a straight line that is in a direction opposite to the above-mentioned direction and extends from the position of the provisional pointing target in the case where the provisional pointing target is placed in a logical space, as a possible area (Step S126).

The mobile terminal then proceeds to F06 in FIG. 14.

The process shown in FIG. 14 is described next. FIG. 14 shows process flow of correcting the current position information (current position coordinates) to the position in the possible area that is closest to the current position information.

First, the mobile terminal obtains estimated position accuracy information indicating the accuracy of the estimated current position coordinates (Step S127).

Next, the mobile terminal obtains the position accuracy (target position accuracy) of the pointing target (Step S128).

Next, the mobile terminal determines whether or not the estimated position accuracy is high (e.g. equal to or more than 80%) (Step S129).

Next, the mobile terminal increases the width of the possible area according to the largeness of the value of the estimated position accuracy information (Step S130). For example, the mobile terminal calculates “((estimated position accuracy)−80)/10*(width of possible area)”, to determine the width of the possible area.

Next, the mobile terminal determines whether or not the position accuracy of the pointing target is low (e.g. equal to or less than 60%) (Step S131).

Next, the mobile terminal increases the width of the possible area according to the smallness of the value of the estimated position accuracy information (Step S132). For example, the mobile terminal calculates “(60−(position accuracy))/10*(width of possible area)”, to determine the width of the possible area.

Next, the mobile terminal corrects the current position information to the position in the possible area closest to the current position information (Step S133).

Next, the mobile terminal determines whether or not the function is completed (Step S134). In the case of determining that the function is completed (Step S134: Yes), the mobile terminal ends the process.

In the case of determining that the function is not completed (Step S134: No), the mobile terminal returns to F08 in FIG. 9 and starts the process.

Though the above describes the case where the mobile terminal performs Step S20 in FIG. 14, i.e. Steps S127 to S132, the mobile terminal may not perform Step S20.

The mobile terminal performs the process as described above.

Though the mobile terminal corrects the current position coordinates (current position) to the coordinates in the calculated possible area that are closest to the current position coordinates, this is not a limit for the present invention. The mobile terminal may correct the current position coordinates to the center of the calculated possible area.

As described above, according to this embodiment, it is possible to realize a position estimation device and a position estimation method capable of estimating a position of the device with high accuracy without requiring installation of special equipment in indoors.

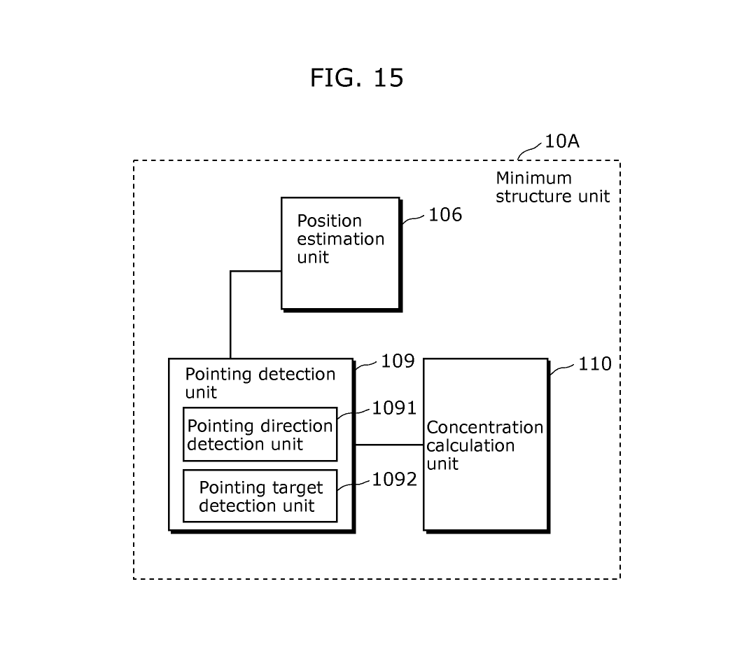

Though this embodiment describes the case where the position estimation device 10 includes the acceleration sensor 101, the angular velocity sensor 102, the geomagnetic sensor 103, the movement state detection unit 104, the posture detection unit 105, the position estimation unit 106, the information storage unit 107, the concentration pattern storage unit 108, the pointing detection unit 109, the concentration calculation unit 110, the position correction unit 111, and the GUI display unit 112, the present invention is not limited to such. As a minimum structure of the position estimation device 10, it is only necessary to include a minimum structure unit 10A shown in FIG. 15. FIG. 15 is a functional block diagram showing a minimum structure of a position estimation device. The minimum structure unit 10A of the position estimation device 10 includes the position estimation unit 106, the pointing detection unit 109 including the pointing direction detection unit 1091 and the pointing target detection unit 1092, the concentration calculation unit 110, and the position correction unit 111. The inclusion of at least the minimum structure unit 10A enables the position of the position estimation device 10 to be estimated with high accuracy, without requiring installation of special equipment indoors.

The position estimation device according to this embodiment may be included in a wireless terminal such as a mobile phone and estimate the current position of the wireless terminal, as described above. However, the position estimation device according to this embodiment is not limited to being included in the target terminal, and may be included in a server such as a cloud connected to the wireless terminal via a network and estimate the current position of the wireless terminal.

The following cases are also included in the present invention.

(1) The position estimation device described above is actually a computer system that includes a microprocessor, a ROM, a RAM, a hard disk unit, a display unit, a keyboard, a mouse, and the like. A computer program is stored in the RAM or the hard disk unit. Functions of each device (apparatus) can be achieved by the microprocessor operating in accordance with the computer program. The computer program mentioned here is a combination of a plurality of instruction codes that represent instructions to a computer for achieving predetermined functions.

For example, as one application example (use case), the position estimation device described above may be included in a pointing device for pointing to arbitrary coordinates on a screen displayed by a display device or the like. In such a case, since the position estimation device is capable of detecting the posture of the pointing device, an object such as an icon in a display window can be selected based on the posture of the pointing device (e.g. the orientation of the top end of the pointing device). By detecting the posture of the pointing device by the position estimation device included in the pointing device in this way, it is possible to exercise control associated with the object.

(2) The position estimation device described above or part or all of the components constituting the position estimation device may be implemented on one system LSI (Large Scale Integrated Circuit). The system LSI is an ultra-multifunctional LSI produced by integrating a plurality of components on one chip, and is actually a computer system that includes a microprocessor, a ROM, a RAM, and the like. A computer program is stored in the RAM. Functions of the system LSI can be achieved by the microprocessor operating in accordance with the computer program. For example, the integrated circuit includes at least the position estimation unit 106, the pointing detection unit 109, and the concentration calculation unit 110.

(3) The position estimation device described above or part or all of the components constituting the position estimation device may be realized by an IC card or a single module that is removably connectable to the device (apparatus) or terminal. The IC card or the module is a computer system that includes a microprocessor, a ROM, a RAM, and the like. The IC card or the module may include the above-mentioned ultra-multifunctional LSI. Functions of the IC card or the module can be achieved by the microprocessor operating in accordance with the computer program. The IC card or the module may be tamper resistant.

(4) The present invention may also be the method described above. The present invention may also be a computer program that realizes the method by a computer. The present invention may also be a digital signal corresponding to the computer program.

In the embodiment, each component may be realized by dedicated hardware or execution of a suitable software program. Each component may also be realized by a program execution unit such as a CPU or a processor reading and executing a software program recorded on a recording medium such as a hard disk or a semiconductor memory.

Software for implementing the position estimation device according to the embodiment or the like is the following program. The program causes a computer to execute a position estimation method for use in a terminal for estimating a position of the terminal, the position estimation method including: estimating current position coordinates indicating a current position of the terminal; detecting a pointing direction which is a direction pointed by a user using the terminal; detecting a pointing target which is a target object pointed by the user, based on the detected pointing direction; specifying, as a concentrated area, an area in which a position pointed in the detected pointing direction in a predetermined time period immediately before the pointing target is detected is included for at least a threshold time period and in which the pointing target is not present, and calculating a concentrated direction which is a direction from the position of the position estimation device in the predetermined time period to the specified concentrated area; and correcting the current position coordinates using the calculated concentrated direction.

The present invention may also be a computer-readable recording medium, such as a flexible disk, a hard disk, a CD-ROM, an MO, a DVD, a DVD-ROM, a DVD-RAM, a BD (Blu-ray Disc), or a semiconductor memory, on which the computer program or the digital signal is recorded. Conversely, the present invention may be the digital signal recorded on such a recording medium.

The present invention may also be the computer program or the digital signal transmitted via an electric communication line, a wired or wireless communication line, a network such as the Internet, data broadcasting, and the like.

The present invention may also be a computer system that includes a microprocessor and a memory. In this case, the computer program may be stored in the memory, with the microprocessor operating in accordance with the computer program.

The computer program or the digital signal may be provided to another independent computer system by distributing the recording medium on which the computer program or the digital signal is recorded, or by transmitting the computer program or the digital signal via the network and the like. The independent computer system may then execute the computer program or the digital signal to function as the present invention.

(5) The above embodiment and variations may be freely combined.

### INDUSTRIAL APPLICABILITY

The position estimation device, the position estimation method, and the integrated circuit according to the present invention are capable of estimating a proper position with a simple structure and process, which contributes to reduced cost. The position estimation device, the position estimation method, and the integrated circuit according to the present invention are therefore applicable to, for example, a mobile terminal such as a mobile phone.

### REFERENCE SIGNS LIST

10 Position estimation device
10A Minimum structure unit
101 Acceleration sensor
102 Angular velocity sensor
103 Geomagnetic sensor
104 Movement state detection unit
105 Posture detection unit
106 Position estimation unit
107 Information storage unit
108 Concentration pattern storage unit
109 Pointing detection unit
110 Concentration calculation unit
111 Position correction unit
112 GUI display unit
1094 Pointing direction detection unit
1092 Pointing target detection unit

1. A position estimation device that estimates a position of the position estimation device, the position estimation device comprising:
a position estimation unit configured to estimate current position coordinates indicating a current position of the position estimation device;
a pointing direction detection unit configured to detect a pointing direction which is a direction pointed by a user using the position estimation device;
a target detection unit configured to detect a pointing target which is a target object pointed by the user, based on the pointing direction detected by the pointing direction detection unit;
a concentration calculation unit configured to specify, as a concentrated area, an area in which a position pointed in the pointing direction detected by the pointing direction detection unit in a predetermined time period immediately before the pointing target is detected by the target detection unit is included for at least a threshold time period and in which the pointing target is not present, and calculate a concentrated direction which is a direction from the position of the position estimation device in the predetermined time period to the specified concentrated area; and
a position correction unit configured to correct the current position coordinates using the calculated concentrated direction.

2. The position estimation device according to claim 1,
wherein the position correction unit is configured to:
calculate a possible area using the concentrated direction with respect to a position of the detected pointing target, the possible area being an area including coordinates at which the position estimation device is likely to be actually present when the user points to the pointing target using the position estimation device; and
determine, in the calculated possible area, coordinates at which the position estimation device is actually present when the user points to the pointing target using the position estimation device and to which the current position coordinates are to be corrected, and correct the current position coordinates to the determined coordinates.

3. The position estimation device according to claim 1, further comprising:
an acceleration sensor;
a geomagnetic sensor;
a posture detection unit configured to detect a posture of the position estimation device based on detection results of the acceleration sensor and the geomagnetic sensor; and
a movement state detection unit configured to detect a movement amount based on the posture detected by the posture detection unit and the detection result of the acceleration sensor, the movement amount indicating a movement direction and a movement distance of the position estimation device,
wherein the position estimation unit is configured to estimate coordinates that are away from previously estimated coordinates by the movement amount detected by the movement state detection unit, as the current position coordinates.

4. The position estimation device according to claim 3, further comprising
an angular velocity sensor,
wherein the posture detection unit is configured to detect the posture of the position estimation device, based on an amount of change of an orientation of the position estimation device detected by the angular velocity sensor and the detection results of the acceleration sensor and the geomagnetic sensor.

5. The position estimation device according to claim 1,
wherein the position estimation unit is further configured to calculate estimated position accuracy which is accuracy of the current position coordinates, based on at least one of: a distance of movement of the position estimation device from coordinates of a reference point passed by the position estimation device most recently; complexity of the movement of the position estimation device; and a time period taken for the movement of the position estimation device, and
the position estimation device further comprises
an information storage unit configured to store the current position coordinates estimated by the position estimation unit and the estimated position accuracy calculated by the position estimation unit, in association with each other.

6. The position estimation device according to claim 5,
wherein the concentration calculation unit is configured to specify, from among a plurality of search areas of a uniform size partitioned for searching for the concentrated area, a search area including an area in which the position pointed in the pointing direction detected by the pointing direction detection unit is concentrated for at least the threshold time period, as the concentrated area, and
the concentration calculation unit is configured to change the size of each of the search areas, according to the current position coordinates and the estimated position accuracy stored in the information storage unit in association with each other.

7. The position estimation device according to claim 6,
wherein the concentration calculation unit is configured to increase the size of each of the search areas to increase a size of the concentrated area, in the case where the estimated position accuracy associated with the current position coordinates is equal to or less than a threshold.

8. The position estimation device according to claim 5,
wherein the information storage unit is further configured to store coordinates of each candidate target which is a candidate for the pointing target, and target position accuracy which is accuracy of the coordinates of the candidate target and is calculated according to a method of registering the candidate target.

9. The position estimation device according to claim 8,
wherein the concentration calculation unit is configured to change a size of the concentrated area, according to the pointing target detected by the target detection unit and target position accuracy of a candidate target corresponding to the pointing target, the target position accuracy being stored in the information storage unit.

10. The position estimation device according to claim 9,
wherein the concentration calculation unit is configured to increase the size of the concentrated area, in the case where the target position accuracy stored in the information storage unit is equal to or less than a threshold.

11. The position estimation device according to claim 5,
wherein the position correction unit is configured to change a size of the possible area, according to the current position coordinates and the estimated position accuracy stored in the information storage unit in association with each other.

12. The position estimation device according to claim 11,
wherein the position correction unit is configured to decrease the size of the possible area, in the case where the estimated position accuracy stored in the information storage unit is equal to or less than a threshold.

13. The position estimation device according to claim 8,
wherein the position correction unit is configured to change a size of the possible area, according to the pointing target detected by the target detection unit and target position accuracy of a candidate target corresponding to the pointing target, the target position accuracy being stored in the information storage unit.

14. The position estimation device according to claim 13,
wherein the position correction unit is configured to increase the size of the possible area, in the case where the target position accuracy stored in the information storage unit is equal to or less than a threshold.

15. The position estimation device according to claim 1, further comprising
a display unit configured to display control information relating to the pointing target, in the case where the pointing target is detected by the target detection unit.

16. The position estimation device according to claim 3,
wherein the movement state detection unit is further configured to detect a terminal movement state indicating that the position estimation device is moving, based on the detection result of the acceleration sensor, and
the position correction unit is configured to, in the case where the terminal movement state is detected by the movement state detection unit and the pointing target is detected by the target detection unit, correct the current position coordinates to coordinates that are away from the coordinates corrected using the calculated concentrated direction by a movement amount of the position estimation device during a time period, in the predetermined time period, from when the concentrated area is specified by the concentration calculation unit to when the pointing target is detected by the target detection unit.

17. A position estimation method for use in a terminal for estimating a position of the terminal, the position estimation method comprising:
estimating current position coordinates indicating a current position of the terminal;
detecting a pointing direction which is a direction pointed by a user using the terminal;
detecting a pointing target which is a target object pointed by the user, based on the detected pointing direction;
specifying, as a concentrated area, an area in which a position pointed in the detected pointing direction in a predetermined time period immediately before the pointing target is detected is included for at least a threshold time period and in which the pointing target is not present, and calculating a concentrated direction which is a direction from the position of the terminal in the predetermined time period to the specified concentrated area; and
correcting the current position coordinates using the calculated concentrated direction.

18. An integrated circuit included in a terminal, the integrated circuit comprising:
a position estimation unit configured to estimate current position coordinates indicating a current position of the terminal;
a pointing direction detection unit configured to detect a pointing direction which is a direction pointed by a user using the terminal;
a target detection unit configured to detect a pointing target which is a target object pointed by the user, based on the pointing direction detected by the pointing direction detection unit;
a concentration calculation unit configured to specify, as a concentrated area, an area in which a position pointed in the pointing direction detected by the pointing direction detection unit in a predetermined time period immediately before the pointing target is detected by the target detection unit is included for at least a threshold time period and in which the pointing target is not present, and calculate a concentrated direction which is a direction from the position of the terminal in the predetermined time period to the specified concentrated area; and
a position correction unit configured to correct the current position coordinates using the calculated concentrated direction.
